(19) United States
(12) Patent Application Publication
(10) Pub. No.: US 2024/0317276 A1
(43) Pub. Date: Sep. 26, 2024

(54) CABLEWAY VEHICLE

(71) Applicant: Innova Patent GmbH, Wolfurt (AT)

(72) Inventors: Dieter Fischnaller, Nuziders (AT); Markus Wolf, Bach (AT); Josef Sutter, Bregenz (AT)

(21) Appl. No.: 18/573,262

(22) PCT Filed: Jun. 24, 2022
(86) PCT No.: PCT/EP2022/067385

§ 371 Date: Dec. 21, 2023

(30) Foreign Application Priority Data
Jun. 25, 2021 (AT) A50524/2021

(51) Int. Cl. B61B 12/00; B62D 35/00

(52) U.S. Cl. CPC B61B 12/002; B62D 35/00

(57) ABSTRACT

A cableway vehicle includes an air turbulence device that is configured to generate a defined flow stall of an air flow flowing around the cableway vehicle during movement of the cableway vehicle, wherein the air turbulence device extends transversely with respect to the direction of movement at least over a part of a width of the cableway vehicle.

### CROSS REFERENCES

The application is a U.S. National Phase Application of International Application No. PCT/EP2022/067385 filed on Jun. 24, 2022, which claims priority to Austrian Application No. A50524/2021, filed on Jun. 25, 2021, the disclosures of each of which are hereby incorporated herein by reference in their entireties.

### TECHNICAL FIELD

The present disclosure relates to cableway vehicles and, more particularly, to cableway vehicles having a suspension for suspending the cableway vehicle on a conveyor cable.

### BACKGROUND

Aerial cableways, referred to in the following as cableways for simplicity, are available in a wide variety of designs, mostly for transporting people and/or goods, for example as urban means of transport or for transporting people in ski resorts. Cableway vehicles such as gondolas, cars or chairs are carried by one or more (wire) cables without fixed guides, and moved while hanging in the air. The cableway vehicles therefore have no contact with the ground. Such cableways are usually used in rough terrain, mostly for mountain routes, for example in ski resorts, to transport people from the valley to a mountain, but also in urban areas for transporting people. Usually, cableways have two or more stations between which the cableway vehicles are moved.

A distinction must be made between circulating cableways and aerial tramways. In the case of aerial tramways, one or two cableway vehicles pulled by a traction cable commute back and forth on a conveyor cable or on rails on a track between two stations. The circulating cableway, on the other hand, has an endless conveyor cable which is constantly circulating between the stations and from which a large number of cableway vehicles such as gondolas or chairs are suspended. Therefore, the cableway vehicles are moved from one station to the other on one side and back again on the opposite side. The movement of the cableway vehicles is therefore always essentially continuous in one direction, and analogous to that of a continuous conveyor.

In order to be able to bridge greater distances, one or more cableway supports for guiding the (carrying/traction) cable(s) are usually arranged between the two stations. Cableway supports can be designed as a steel framework construction, but also as a steel tube or sheet metal box construction. A plurality of rollers, for example in the form of a so-called sheave assembly, are usually arranged on a cableway support in order to carry and guide the cable or cables. In the case of circulating cableways, the cableway vehicles are usually fastened to the conveyor cable at a defined distance from one another. In order to ensure that the conveyor cable and the cableway supports are loaded as evenly as possible, the distances between the large number of cable cars on a cableway are usually the same. The distance between the cableway vehicles can of course vary depending on the specific cableway design. For example, the distance between the chairs of a chairlift will be smaller than the distance between the gondolas of a gondola cableway, etc.

In modern circulating cableways, the cableway vehicles are usually not permanently connected to the conveyor cable, but are connected by means of detachable grips. As a result, the cableway vehicles can be decoupled from the conveyor cable in the stations and moved through the station at a speed that is lower than the speed of the conveyor cable. In particular when transporting passengers, this increases the comfort and safety for the passengers because more time is available for getting on and off. When exiting the station, the cableway vehicles are then clamped to the conveyor cable again by means of the detachable grips.

The cableway vehicles are preferably accelerated again to the speed of the circulating conveyor cable in order to avoid abrupt acceleration and impact loads. Due to the development toward greater conveying capacity and shorter transport times, in addition to the size and capacity of the cableway vehicles, the conveying speed of the conveyor cable has of course also increased in recent years. The fact that the cable cars are decoupled in the stations, and the ever-increasing conveying speeds, must of course also be taken into account when setting the distance between the individual cableway vehicles. There are also cableways having cableway vehicles firmly clamped to the conveyor cable.

During operation of a cableway, due to various influencing variables, undesired transverse vibrations of the conveyor cable can occur, in particular in the vertical direction. Such vibrations not only adversely affect the comfort of the passengers, but can also have a negative effect on the availability of the cableway system and the service life of individual components. In the worst case, cable vibrations can lead, for example, to the conveyor cable jumping out of a guide roller of a cableway support. Operational influencing variables of such cable vibrations are, for example, the number and the weight of cableway vehicles coupled to the conveyor cable, the loading of the cableway vehicles, the distance between the cableway vehicles, the length of the cable spans between two cableway supports, the cyclic loading and unloading by coupling or decoupling the cableway vehicles to or from the conveyor cable, and drive forces introduced into the conveyor cable, etc.

These influencing variables resulting from operation lead to temporally variable cable forces in the conveyor cable, which can lead to vibration excitation. Some of the influencing variables caused by operation (e.g. the length of the cable spans, the number and weight of cableway vehicles) can be taken into account for example when designing a cableway, but are substantially not variable, or can be varied only with great effort, during operation of the cableway. Other operational influencing variables can, in turn, be influenced during the operation of the cableway, e.g. the loading of the cableway vehicles or the drive forces introduced into the conveyor cable, e.g. for accelerating the conveyor cable from a standstill.

There are also external weather-related variables that influence the cable vibrations, which cannot be altered and are also difficult or impossible to predict. In corresponding wind conditions, aerodynamic wind forces act on the cableway vehicles due to the external shape of the cableway vehicles. These wind forces can be interrelated with the operational cable vibrations that are present, and in certain cases can stimulate eigenmodes of the cable dynamics in the vertical direction as well as a lateral oscillation of the cableway vehicles transversely to the direction of movement. In rare cases, especially in the case of flat cable spans with heavy cableway vehicles and with corresponding topological properties of the cable run, when there is a certain vector field of the wind, temporally variable aerodynamic effects can arise which can cause self-excitation phenomena of the cable vibration (e.g. transverse cable vibration in the 2nd mode, or laterally vibrating vehicles).

These self-excitation phenomena are essentially due to state-dependent flow coefficients of the flow around the vehicle, for example a variable lift coefficient (ca-value), a variable drag coefficient (cw-value) or a variable torque coefficient (cm-value). These state-dependent flow coefficients can cause a vibration-exciting change in cable force in the conveyor cable as a function of the aerodynamics. To avoid critical natural vibrations of the conveyor cable, up to now attempts have been made in the prior art to adapt the operational influencing variables mentioned above, for example by selecting a specific length of cable spans, selecting a specific number of cableway vehicles or the distance between cableway vehicles. However, due to the rapidly changing and difficult-to-predict weather conditions, the avoidance of vibrations via the design of the cableway has not always led to satisfactory results.

WO 2006/077474 A1 discloses a chair for a chairlift, on the underside of which a guide device is arranged which serves to avoid air turbulence as far as possible. This is intended to ensure that the chairs run as stably as possible.

In addition, devices are known which aim to reduce lateral oscillations of the cableway vehicles. FR 2739604 A1 discloses, for example, a cableway cabin with an aerodynamic guide element that serves to compensate for lateral pendulum vibrations caused by crosswinds. Similarly to FR 2739604 A1, FR 2736607 A1 discloses a cableway cabin on which a plurality of aerodynamic guide elements are arranged which are directed opposite the crosswind. The guide elements serve to reduce the turbulence-induced air resistance and to increase the vertical force. SU 804539 A1 discloses a cableway cabin on the roof of which a wing having a stabilizing fin is arranged. Similarly to FR 2739604 A1 and FR 2736607 A1, the wing serves to increase the vertical force (almost like a virtual mass) in the event of a lateral wind and thus to stabilize the cabin against lateral vibrations. However, the guide devices are unsuitable for reducing vertical vibrations.

It is therefore an object of the present disclosure to avoid critical vibration states of cableway vehicles and consequently of the conveyor cable, in particular in the vertical direction, during operation of a cableway in order to increase the safety of the operation of the cableway.

### SUMMARY

The object is achieved by a cableway vehicle mentioned at the outset in that an air turbulence device is provided on the cableway vehicle, which air turbulence device extends transversely to the direction of movement at least over a portion of the cableway vehicle and which is designed to generate a defined flow stall of a flow of air flowing around the cableway vehicle in the direction of movement during the movement of the cableway vehicle, wherein the air turbulence device extends transversely to the direction of movement at least over some of a width of the cableway vehicle. In the context of the present disclosure, a defined flow stall is understood to mean a substantially locally constant and preferably high-frequency flow stall of the air flow on the cableway vehicle independently of the vector field of the wind which acts on the cableway vehicle. The separation behavior of a boundary layer flow on the cableway vehicle can be stabilized by the air turbulence device, whereby a temporal change of the aerodynamic forces and moments acting on the cableway vehicle can be reduced. This subsequently leads to a virtually time-constant pressure distribution and shear stress distribution on the surface of the cableway vehicle. In the context of the present disclosure, an air turbulence device means, for example, suitable spoilers, turbulators and other structural elements that lead to a defined flow stall during the flow of air around the cableway vehicle and consequently to a pressure distribution and shear stress distribution on the surface of the cableway vehicle that is as constant as possible over time. The air turbulence device is therefore not used to direct the flow in a targeted manner, as is the case in the above-mentioned prior art, but instead generates a flow stall. The air turbulence device thus has precisely the opposite effect.

In order to increase the effect, the air turbulence device preferably extends over at least 30% of a width of the cableway vehicle, preferably at least 50%, particularly preferably at least 70%. It can also be advantageous if a width of the air turbulence device transverse to the direction of movement of the cableway vehicle is at least twice, preferably at least five times, particularly preferably at least ten times, as large as a length of the air turbulence device in the direction of movement.

According to an advantageous embodiment, it is provided that the cableway vehicle has a carrier for receiving persons which is connected to the suspension, and that a portion of the air turbulence device is arranged above the carrier in an upper region of the cableway vehicle and/or that a portion of the air turbulence device is arranged below the carrier in a lower region of the cableway vehicle and/or that a portion of the air turbulence device is arranged laterally on the carrier in a lateral region of the cableway vehicle. It is advantageous here if the part of the air turbulence device provided laterally on the cableway vehicle extends at least over a portion of a height of the cableway vehicle, preferably over at least 30% of a height of the transport body, particularly preferably over at least 50%. It is also advantageous if a height of the part of the air turbulence device provided laterally on the cableway vehicle in the vertical direction is at least twice as large as its length in the direction of movement.

The air turbulence device can, for example, have a plurality of projections and/or a plurality of recesses arranged one behind the other in the direction of movement and/or transversely to the direction of movement and/or in the vertical direction, the projections preferably having a height of at least 5 mm, particularly preferably at least 10 mm, in particular at least 30 mm, and/or the recesses preferably having a depth of at least 5 mm, particularly preferably at least 10 mm, in particular at least 30 mm.

According to a preferred embodiment, the air turbulence device has at least one air turbulence element which is fastened to the cableway vehicle, in particular to the carrier, by a fastening means. As a result, the air turbulence element can be replaced easily or, for example, an existing cableway vehicle can easily be retrofitted with an air turbulence device. It can be advantageous here if the air turbulence device has at least two air turbulence elements which are arranged on the cableway vehicle, in particular on the carrier, at a distance from one another in the direction of movement and/or transversely to the direction of movement and/or in the vertical direction. In this way, assembly can be facilitated, e.g. in the case of relatively long air turbulence elements, and the air turbulence device can be better adapted to the contour of a cableway vehicle.

In order to improve the desired effect of the air turbulence device, it can be advantageous if at least one air turbulence element is at least partially air-permeable in the direction of movement and/or that at least one portion of at least one air turbulence element is flexible. According to an advantageous embodiment, at least one air turbulence element can have a brush-like element, a net, a perforated sheet, a mesh or a rubber lip.

If the carrier is designed as a cabin, part of the air turbulence device can, for example, be arranged on the roof of the cabin and/or on a side wall of the cabin and/or on the floor of the cabin.

If the carrier has a chair having a weather protection hood for covering the chair, movable between an open position and a closed position, the air turbulence device is preferably provided on the weather protection hood. In the closed position of the weather protection hood, the air turbulence device is preferably arranged on the outside and/or on the inside of the weather protection hood. In order to be able to make use of the effect of the air turbulence device in the closed position, it is advantageous if, in the closed position of the weather protection hood, the air turbulence device is arranged on the outside of the weather protection hood in the region of the highest point when viewed in the vertical direction. If the weather protection hood has a curved outer surface, it is then advantageous for example if the air turbulence device is provided in the region of an apex of the curved outer surface.

In order to be able to make use of the effect of the air turbulence device additionally or alternatively in the open position of the weather protection hood, it is advantageous if, in the open position of the weather protection hood, the air turbulence device is provided in the region of the highest point of the weather protection hood, when viewed in the vertical direction, in particular in the region of a front edge of the weather protection hood delimiting the weather protection hood. Alternatively or additionally, the weather protection hood can have a curved inner surface and, in the open position of the weather protection hood, the air turbulence device can be arranged between the front edge of the weather protection hood and an apex of the curved inner surface of the weather protection hood on the inner surface of the weather protection hood when viewed in the direction of movement.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 is a schematic view of a cableway according to an embodiment of the present disclosure.

FIG. 2a shows a cableway vehicle comprising a chair having a weather protection hood in a closed position according to an embodiment of the present disclosure.

FIG. 2b shows a cableway vehicle comprising a chair having a weather protection hood in an open position according to an embodiment of the present disclosure.

FIG. 3 shows a cableway vehicle comprising a cabin according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

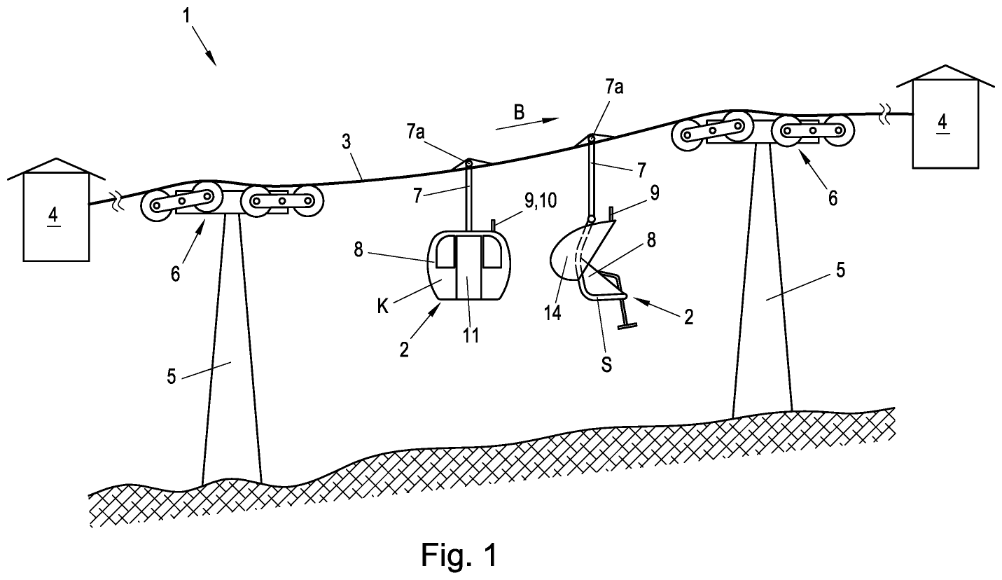

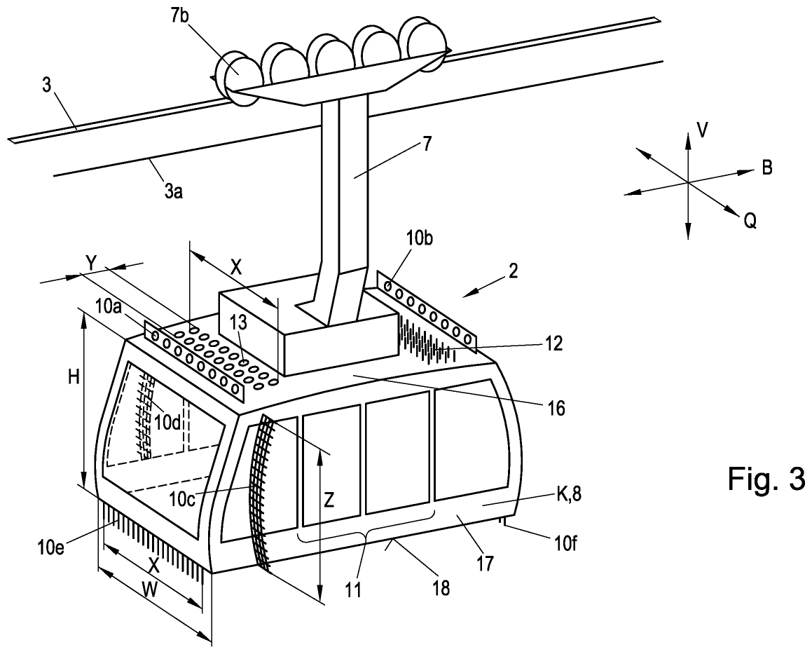

FIG. 1 shows a cableway 1 having two cableway vehicles 2 which can be moved between two cableway stations 4 by means of a conveyor cable 3, the cableway stations 4 being indicated merely schematically. The cableway 1 can be designed, for example, as a known circulating cableway or as a known aerial tramway. The cableway 1 generally has a plurality of cableway supports 5, on which the conveyor cable 3 is guided, for example via known sheave assemblies 6. The number of cableway supports 5 depends, for example, on the distance between the end stations 4 of the cableway and on the expected load from the cable vehicles 2, but also on the topology of the terrain in which the cableway 1 is operated. The cableway supports 5 are used to carry and guide the conveyor cable 3. For the sake of simplicity, only two cableway supports 5 are shown in FIG. 1. The conveyor cable 3 thus forms a direction of movement B in which the cableway vehicles 2 can be moved. In some embodiments, a plurality of parallel conveyor cables 3 and, if applicable, a traction cable 3a (FIG. 3) which circulates or runs back and forth can also be provided. In the following example, however, the present disclosure is explained using only one conveyor cable 3, but of course the present disclosure can also be applied to cableways with a plurality of conveyor cables 3 and/or traction cables. The structure and function of such cableways 1 are well known, and therefore they will not be discussed in more detail at this point.

The cableway vehicles 2 each have a suspension 7 with which they can be suspended from the conveyor cable 3. The cableway vehicles 2 can, for example, be coupled fixedly or releasably to the conveyor cable 3 by means of suitable detachable grips 7a. The cableway vehicles 2 are generally fastened to the conveyor cable 3 at a fixed distance from one another, where the distance depends substantially on the specific design of the cableway 1. In the case of aerial tramways, only one cableway vehicle 2 with a relatively large transport capacity is usually provided per direction.

In the case of circulating cableways, however, a large number of cableway vehicles 2 are arranged on the conveyor cable 3. In the case of circulating cableways, the cableway vehicles 2 can often be decoupled from the conveyor cable 3 in the cableway stations 4 and can be moved within the cableway station 4 at a reduced speed in order to make it easier to get on and off.

If the cableway vehicles 2 are intended for passenger transport, the cableway vehicles 2 usually have a carrier 8 for accommodating one or more persons. The carrier 8 can, for example, be an enclosed cabin K, which can be accessible for getting on and off e.g. via at least one door 11. Such a cableway vehicle 2 having a cabin K is shown on the left in FIG. 1. However, the carrier 8 can also be a chair S, for example, as shown by means of the cableway vehicle 2 on the right in FIG. 1. In order to protect against weather, also a weather protection hood 14 can be provided on the chair S. A cableway 1 can, for example, be designed as a cabin lift, in which all cableway vehicles 2 have a cabin K, or can be designed as a chairlift, in which all cableway vehicles 2 have a chair S. However, mixed operation would also be conceivable in principle, in which both cableway vehicles 2 comprising the cabin K and cableway vehicles 2 comprising the chair S are moved on the conveyor cable 3. The cableway stations 4 are designed depending on the specific embodiment of the cableway 1. In a cabin lift, the doors are usually arranged on the side of the cabin so that entry and exit within the cableway stations takes place transversely to the direction of movement B. With chairlifts, on the other hand, access is usually from the front when viewed in the direction of movement.

As mentioned at the outset, during operation of the cableway 1 transverse or in particular vertical cable vibrations of the conveyor cable 3 can occur which result from an interaction of operational influencing variables and weather-related influencing variables, in particular from the wind. In addition, the weather-related influencing variables can also excite the cableway vehicles 2 to perform a pendulum movement transversely to the direction of movement B. The conveyor cable 3 here substantially forms an axis of rotation about which the cableway vehicle 2 oscillates. To a certain extent, both transverse vibrations of the conveyor cable 3 and pendulum movements of the cableway vehicles 2 are standard, and occur during normal operation of a cableway. Under unfavorable circumstances, in particular due to wind direction and speed that are difficult to predict and change in terms of time and location, the vibrations can also build up, essentially as a result of the time-varying aerodynamic flow effects, mentioned at the outset, on the cableway vehicles 2. If an excitation frequency of the vibration system is in the range of its natural frequency, in the worst case, resonance phenomena and consequently safety-critical vibration states can occur, which must be avoided during operation of the cableway. In order to avoid this, attempts have so far usually been made to influence the vibration excitation via the available operational influencing variables, for example by reducing the speed of the cableway, in particular the conveyor cable 3, if warranted until the cableway 1 comes to a standstill.

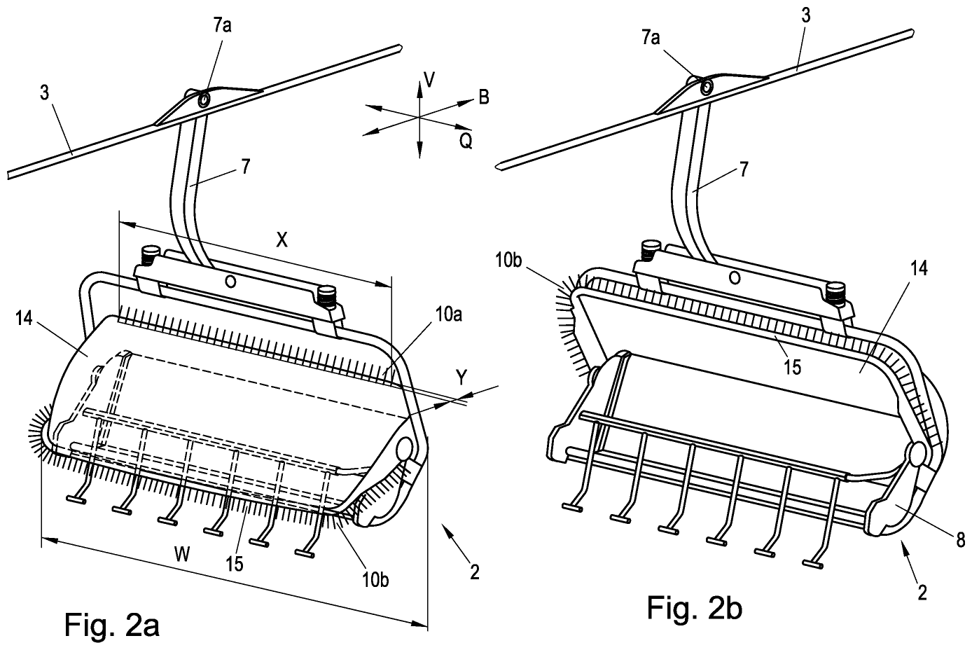

In the present disclosure, on the other hand, the excitation of the vibration system by the weather-related influencing variables, in particular the wind is reduced. For this purpose, an air turbulence device 9 is provided on at least one cableway vehicle 2, which air turbulence device is designed to generate a defined flow stall of a flow of air flowing around the cableway vehicle 2 in the direction of movement B during the movement of the cableway vehicle 2. Here the air turbulence device 9 extends transversely to the direction of movement B (transverse direction Q-FIG. 2a-FIG. 3) at least over some of a width W of the cableway vehicle 9 (FIG. 2a-FIG. 3). As a result, even given temporally and locally variable flow conditions (in particular variable wind direction and speed) it can be ensured that the flow stall of the air flow substantially always takes place at the same location on the cableway vehicle 2. The aerodynamic flow effects varying over time are thereby weakened.

In FIG. 1, an air turbulence device 9 is provided on each of the cableway vehicles 2, which air turbulence device extends transversely to the direction of movement B over some of the width W (FIG. 2a-FIG. 3) of the corresponding cableway vehicle 2. In the context of the present disclosure, “transverse” does not necessarily mean orthogonal, i.e. 90°, to the direction of movement B; rather, the air turbulence device 9 could also be arranged at a certain angle to the (orthogonal) transverse direction Q of the cableway vehicle 2. The air turbulence device 9 can be arranged at a suitable location on the cableway vehicle 2, preferably on the carrier 8 (e.g. cabin K or chair S). The air turbulence device 9 shown in FIG. 1 has, for example, an air turbulence element 10 which is fastened to an outer surface on the carrier 8 by a suitable fastening means.

Depending on the design of the air turbulence element 10, a non-releasable fastening means, e.g. a suitable adhesive, can be used as the fastening means, or a suitable releasable fastening means, such as a screw connection, etc., could be used. Of course, this is only to be understood by way of example and the specific position and specific design of the air turbulence device 9 can be chosen essentially as desired as long as the air turbulence device 9 is suitable for producing the defined flow stall effect of the air flow flowing around the cableway vehicle 2 in accordance with the present disclosure. Depending on the type of cableway 1 and cableway vehicles 2, a person skilled in the art can select a suitable position and design for the air turbulence device 9.

Optionally, for example, two or more air turbulence elements 10 can also be provided, which are arranged on the cableway vehicle 2, in particular on the carrier 8, at a distance from one another in the direction of movement B and/or in the transverse direction Q, transversely to the direction of movement and/or in the vertical direction V (see FIG. 2a+2b). An air turbulence element 10 can, for example, be at least partially air-permeable in the direction of movement B and/or at least a portion of the air turbulence element 10 can be flexible, for example made of a resilient material. The air turbulence element 10 can, for example, also have a brush-like element, a net, a perforated sheet or a mesh or a rubber lip. The embodiment of the air turbulence device 9 as an air turbulence element 10 has the advantage, for example, that existing cableways 1 can be easily retrofitted with an air turbulence device 9 according to the present disclosure without requiring significant structural changes to the cableway vehicles 2.

Alternatively or in addition to an air turbulence element 10, the air turbulence device 9 can, for example, also have a plurality of projections 12 (FIG. 3) arranged one behind the other (not shown in FIG. 1) and/or a plurality of recesses 13 (FIG. 3) arranged one behind the other in the direction of movement B and/or in the transverse direction Q and/or in the vertical direction V. The projections 12 protrude from the surface on which they are arranged and can, for example, have a height of at least 5 mm, preferably at least 10 mm, particularly preferably at least 30 mm. The recesses 13 can, for example, have a depth of at least 5 mm, preferably at least 10 mm, particularly preferably at least 30 mm. As a result, the air turbulence device 9 can be designed, for example, as an integral component of the carrier 8, for example in the form of recesses 12 in the weather protection hood of a chair S or in the outer surface of a cabin K, as indicated in FIG. 3. The recesses 12 can, for example, fulfill a function similar to the known “dimples” on a golf ball.

In order to increase the effect of the air turbulence device 9, it is advantageous for example if the air turbulence device 9 extends over at least 30% of a width W (FIG. 2a+FIG. 3) of the cableway vehicle 2, in particular of the carrier 8, preferably at least 50%, particularly preferably at least 70%. In addition, it is advantageous if a width X of the air turbulence device 9 in the transverse direction Q of the cableway vehicle 2 (see FIG. 2a+FIG. 3) is at least twice, preferably at least five times, particularly preferably at least ten times as large as a length Y of the air turbulence device 9 in the direction of movement B. A narrow and wide air turbulence device 9 with a relatively sharp flow stall edge for the air flow is thereby formed, which improves the effect.

Part of the air turbulence device 9 can, for example, be arranged in an upper region of the cableway vehicle 2 above the carrier 8, preferably directly on the carrier 8, as shown in FIG. 1. However, part of the air turbulence device 9 could also be arranged, for example, in a lower region of the cableway vehicle 2 below the carrier 8, for example on the underside of a floor of the cabin K (or the chair S), as indicated in FIG. 3. Likewise, part of the air turbulence device 9 could also be arranged in a lateral region of the cableway vehicle 2, for example laterally on the carrier 8, in order to reduce lateral oscillation of the cableway vehicle 2 (see FIG. 3). For example, the part of the air turbulence device 9 provided laterally on the cableway vehicle 2 can extend at least over some of a height of the cableway vehicle 2, preferably over at least 30%, particularly preferably over at least 50% of a height H of the carrier 8 (e.g. cabin K or chair S comprising weather protection hood). A height Z of the part of the air turbulence device 9 which is provided laterally on the cableway vehicle 2 in the vertical direction V is preferably at least twice as large as its length Y in the direction of movement B. The height Z in the vertical direction V here relates to the active state of the air turbulence device 9, for example to the air turbulence element 10b described in more detail below with reference to FIG. 2a+2b, in the open position of the weather protection hood 14 according to FIG. 2b or the air turbulence elements 10c, 10d in FIG. 3 described in more detail below with reference to FIG. 3.

Exemplary advantageous embodiments of the air turbulence device 9 according to the present disclosure will be explained below with reference to FIG. 2a+2b and FIG. 3. FIG. 2a+2b each show a cableway vehicle 2 having a carrier 8 in the form of a chair S on which a weather protection hood 14 is provided for covering the chair S. The weather protection hood 14 can be manually moved in a known manner by the passengers between an open position shown in FIG. 2b and a closed position shown in FIG. 2a. In the closed position, the passengers are protected from the weather. The weather protection hood 14 is usually at least partially transparent and generally has a curved outer surface. Such weather protection hoods 14 are known in principle, which is why they will not be discussed in detail here. In the example shown, the air turbulence device 9 has a first air turbulence element 10a and a second air turbulence element 10b, which are provided on the weather protection hood 14. The two air turbulence elements 10a, 10b are designed here as brush-like elements which have a plurality of bristles, preferably flexible bristles, protruding from the weather protection hood 14. The brush-like element can, for example, have a base body made of a suitable plastics on which the bristles are arranged.

Depending on the size of the cableway vehicle 2, a height of the base body can be, for example, a few millimeters to a few centimeters, and a height of the bristles is preferably at least 10 mm, preferably at least 25 mm, particularly preferably at least 40 mm. A length of the base body (in the direction of movement B) can also be a few millimeters to a few centimeters and is preferably of such a size that sufficiently stable fastening to the cableway vehicle 2 is enabled. In successful tests, for example a brush-like element with a base body having a length (in the direction of movement B) of 25 mm, a height of 8 mm and a bristle length of 50 was used. The brush-like element can be glued to the cableway vehicle, for example by the side of the base body opposite the bristles.

The first air turbulence element 10a is preferably arranged on the outside of the weather protection hood 14 in such a way that, in the closed position of the weather protection hood 14, it is located in the region of the highest point of the weather protection hood 14 when viewed in the vertical direction V. If the weather protection hood 14 has a curved outer surface, as shown in FIG. 2a, the first air turbulence element 10a can be provided for example in the area of an apex of the curved outer surface. The air flow can thereby be influenced when the weather protection hood 14 is in the closed position in order to reduce vibration excitation. “In the region” of the highest point or of the apex here means that the first air turbulence element 10a, or generally the air turbulence device 9, does not necessarily have to be arranged exactly at the highest point or apex, but rather that of course there is a certain amount of leeway for the arrangement in the direction of movement B of the cableway vehicle 2. The air turbulence device 9 or the first air turbulence element 10a could, for example, also be arranged in front of or behind the highest point or the apex of the curved outer surface of the weather protection hood 14 in the direction of movement B. Likewise, the first air turbulence element 10a, or generally the air turbulence device 9, could also be arranged at a certain angle relative to the transverse direction Q, contrary to the representation in FIG. 2a. The arrangement along a straight line (here in the transverse direction Q) is of course also to be understood only as an example. The first air turbulence element 10a could, for example, also be arranged in a meandering shape on the weather protection hood 14.

If the effect of vibration reduction according to the present disclosure is intended to occur when the weather protection hood 14 is in the open position, it can be advantageous if the air turbulence device 9 is arranged on the weather protection hood 14, for example, in such a way that, in the open position of the weather protection hood 14, the air turbulence device is located in the region of the highest point of the weather protection hood 14 when viewed in the vertical direction. In the example shown, the air turbulence device 9 comprises the second air turbulence element 10b for this purpose, which is arranged in the region of a front edge 15 of the weather protection hood 14 delimiting the weather protection hood 14. In particular, in the example shown, the brush-like second air turbulence element 10b runs along the entire front edge 15 of the weather protection hood 14 so that in each case a portion of the second air turbulence element 10b is also located at the two sides of the carrier 8, as can be seen in FIG. 2a and FIG. 2b.

However, the embodiment shown is of course only to be understood by way of example, and the air turbulence device 9 could also be designed differently. For example, only one of the air turbulence elements 10a, 10b could be provided or the air turbulence elements 10a, 10b could be designed differently. Alternatively or in addition to the two air turbulence elements 10a, 10b, the air turbulence device 9 could also have the above-mentioned projections 12 or recesses 13, for example. As has surprisingly been found in tests, an air turbulence device 9 arranged on the inside of the weather protection hood 14 can also lead to a vibration reduction during operation of the cableway 1. For example, in the embodiment according to FIG. 2a+2b, alternatively or in addition to the air turbulence elements 10a, 10b shown, a brush-like (or otherwise designed) air turbulence element (not shown) could be arranged on the concave inner side of the curved weather protection hood 14 for this purpose. When viewed in the direction of movement B, the air turbulence element could, for example, be arranged in a region between the front edge 15 delimiting the weather protection hood 14 and the apex on the concave inner side of the weather protection hood 14, and extend in the transverse direction Q at least over some of the width W of the cableway vehicle 2. As a result, in the open position of the weather protection hood 14, a defined flow stall edge for the air flow can also be formed, which air flow flows around the weather protection hood 14 on its inner side, thereby enabling prevention of critical vibration excitation.

FIG. 3 shows a cableway vehicle 2 which has a cabin K as the carrier 8. A passenger compartment provided inside the cabin K is accessible via a door 11 provided on the side of the cabin K. The cableway vehicle 2 shown is intended for example for use in an aerial tramway, and has a suspension 7 having a running gear 7b. A plurality of rollers which roll on the conveyor cable 3 are provided on the running gear 7b. The drive takes place here via an additional traction cable 3a. Of course, this is to be understood only as an example, and the cableway vehicle 2 could also be designed for use in a circulating cableway and have a detachable grip 7a for fastening to a movable conveyor cable 3.

Part of the air turbulence device 9 according to the present disclosure can be arranged for example on the roof 16 of the cabin K and/or on a side wall 17 of the cabin and/or on the floor 18 of the cabin K in this case. FIG. 3 shows several possible embodiments of the air turbulence device 9 by way of example only, which of course do not necessarily have to be used together. When viewed in the direction of movement B, in the front and rear region of the cableway vehicle 2 an air turbulence element 10a, 10b is arranged on the roof of the car. The air turbulence elements 10a, 10b are designed for example in the form of perforated plates and are thus partially air-permeable in the direction of movement B. The shape, number and spacing between the holes in the perforated plate are suitably defined so that an advantageous flow stall of the air flow on the cableway vehicle 2 is achieved during operation of the cableway 1.

Furthermore, in the direction of movement B between the first air turbulence element 10a and the suspension 7, a plurality of recesses 13 are provided in the roof 16 of the cabin K, which recesses form part of the air turbulence device 9 and which can be provided in the cableway vehicle 2 independently of the air turbulence elements 10a, 10b. As can be seen in FIG. 3, a plurality of recesses 13 can be arranged one behind the other, for example when viewed in the transverse direction Q and/or in the direction of movement B, so that a grid having a length Y and a width X is formed on the roof 16 of the cabin K. Here, the recesses 13 can be arranged one behind the other in the transverse direction Q and in the direction of movement B, e.g. along a straight line in each case, so that a regular grid results. However, an irregular arrangement would of course also be conceivable.

Alternatively or in addition to the recesses 13, projections 12 could also be provided which can for example also be arranged in a grid pattern, as indicated in the region between the second air turbulence element 10b and the suspension 7. The projections 12 can protrude from the roof 16 of the cabin K, an intermediate space being formed between the projections 12 so that the air turbulence device 9 is partially air-permeable when viewed in the direction of movement B. The shape, size, number and spacing between the recesses 13, or the projections 12 are suitably defined so that an advantageous flow stall of the air flow on the cableway vehicle 2 is achieved during operation of the cableway 1.

Here, a further third air turbulence element 10c having a height Z in the vertical direction V and a substantially smaller length Y relative thereto in the direction of movement B is provided on the side wall 17 of the cabin K. The third air turbulence element 10c is designed in the form of a net here and has only for example a slight curvature. Of course, a fourth air turbulence element 10d could also be provided on the opposite side wall in an analogous manner, as indicated in FIG. 3.

Likewise, a part of the air turbulence device 9 according to the present disclosure could also be provided on the floor 18 below the cabin K, as indicated in FIG. 3 by the fifth and sixth air turbulence element 10e, 10f. The air turbulence elements 10e, 10f are in turn designed in the manner of brushes only by way of example, as already described with reference to the chair S in FIG. 2a+2b.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

1. A cableway vehicle for a cableway movable by a conveyor cable in a direction of movement and having a suspension for suspending the cableway vehicle from the conveyor cable, comprising:
an air turbulence device on the cableway vehicle configured to generate a defined flow stall of an air flow flowing around the cableway vehicle during movement of the cableway vehicle;
wherein the air turbulence device extends transversely with respect to the direction of movement at least over some of a width of the cableway vehicle.

2. The cableway vehicle according to claim 1, wherein the air turbulence device extends over at least 30% of the width of the cableway vehicle.

3. The cableway vehicle according to claim 1, wherein a width of the air turbulence device transverse to the direction of movement is at least twice as large as a length of the air turbulence device in the direction of movement.

4. The cableway vehicle according to claim 1, wherein the cableway vehicle comprises a carrier configured to receive persons and connected with the suspension; and wherein a portion of the air turbulence device is arranged:
above the carrier in an upper region of the cableway vehicle;
below the carrier in a lower region of the cableway vehicle; or
laterally on the carrier in a lateral region of the cableway vehicle.

5. The cableway vehicle according to claim 4, wherein a portion of the air turbulence device provided on a side of the cableway vehicle extends at least over some of a height of the cableway vehicle.

6. The cableway vehicle according to claim 4, wherein a height of a portion of the air turbulence device provided on a side of the cableway vehicle in a vertical direction is at least twice as large as its length in the direction of movement.

7. The cableway vehicle according to claim 1, wherein the air turbulence device comprises, in at least one of the direction of movement, transversely to the direction of movement, and in a vertical direction, at least one of:
a plurality of projections arranged one behind the other; and
a plurality of recesses arranged one behind the other.

8. The cableway vehicle according to claim 7, wherein the plurality of projections have a height of at least 5 mm and the plurality of recesses have a depth of at least 5 mm.

9. The cableway vehicle according to claim 1, wherein the air turbulence device further comprises at least one air turbulence element fastened to the carrier.

10. The cableway vehicle according to claim 9, wherein the air turbulence device comprises at least two air turbulence elements spaced apart from one another on the carrier in the direction of movement, transversely to the direction of movement, or in the vertical direction.

11. The cableway vehicle according to claim 9, wherein the at least one air turbulence element is at least partially air-permeable in the direction of movement; or the at least one air turbulence element is flexible.

12. The cableway vehicle according to claim 9, wherein the at least one air turbulence element comprises at least one of a brush-like element, a net, a perforated plate, a mesh, and a rubber lip.

13. The cableway vehicle according to claim 4, wherein the carrier comprises a cabin having a roof, a floor, and at least one side wall and wherein a portion of the air turbulence device is on at least one of the roof, at least one of the side walls, and the floor.

14. The cableway vehicle according to claim 4, wherein the carrier comprises a chair and a weather protection hood configured to cover the chair, wherein the weather protection hood is displaceable between an open position and a closed position, and wherein the air turbulence device is on the weather protection hood.

15. The cableway vehicle according to claim 14, wherein the air turbulence device is on at least one of an outside and an inside of the weather protection hood when the weather protection hood is in the closed position.

16. The cableway vehicle according to claim 14, wherein, in the closed position of the weather protection hood, the air turbulence device on the outside of the weather protection hood adjacent a highest point of the weather protection hood when viewed in the vertical direction.

17. The cableway vehicle according to claim 14, wherein the weather protection hood comprises a curved outer surface, and wherein the air turbulence device is adjacent to an apex of the curved outer surface.

18. The cableway vehicle according to claim 14, wherein, in the open position of the weather protection hood, the air turbulence device is adjacent a front edge of the weather protection hood delimiting the weather protection hood.

19. The cableway vehicle according to claim 14, wherein the weather protection hood comprises a curved inner surface and wherein, in the open position of the weather protection hood, the air turbulence device is on an inner surface of the weather protection hood between a front edge delimiting the weather protection hood and an apex of the curved inner surface.

20. A cableway having a plurality of cableway vehicles movable between at least two cableway stations with a conveyor cable, comprising at least one cableway vehicle according to claim 1.
